(19) United States
(12) Patent Application Publication
(10) Pub. No.: US 2013/0061310 A1
(43) Pub. Date: Mar. 7, 2013

(54) SECURITY SERVER FOR CLOUD COMPUTING

(71) Applicant: Wesley W. Whitmyer, JR., Stamford, CT (US)

(72) Inventor: Wesley W. Whitmyer, JR., Stamford, CT (US)

(21) Appl. No.: 13/313,856

(22) Filed: Dec. 7, 2011

Related U.S. Application Data
(60) Provisional application No. 61/531,517, filed on Sep. 6, 2011.

(51) Int. Cl. G06F 21/00; G06F 15/16

(52) U.S. Cl. 726/9; 726/3; 726/5

(57) ABSTRACT

A system, method, and server improving the security of accessing Internetworked computer resources, especially over public access connections, without requiring additional servers from either the resource provider or the authenticating user. User authentications are transmitted over data access connections over which users do not have administrative rights and/or physical security control. A resource request which includes user authentications can be encrypted on a user computer and transmitted over the internet or other data network over which the user has no administrative access or physical control. A security server receives the encrypted resource request, decrypts it, and forwards the resource request to a cloud computing resource.

### CROSS-REFERENCE TO RELATED APPLICATIONS

The present application claims the benefit under 35 U.S.C. §119(e) of the U.S. Provisional Patent Application Ser. No. 61/531,517, filed on Sep. 6, 2011, the content of which is incorporated herein by reference.

### FIELD OF THE INVENTION

This application relates to cloud computing in general, and is directed to communications over insecure access connections for cloud computing in particular.

### BACKGROUND OF THE INVENTION

Systems for authenticating users to computer systems and networks, including cloud-based resources, are known. The most well-known such system is a simple username and password combination. Concerns over identity theft have led users and resource providers to additional layers of security, such as longer and more complicated passwords and so-called multifactor authentication.

Multifactor authentication is fairly common now and adds a security token to the username and password combination. An underlying principle of multifactor authentication is to combine “something you know” e.g., a password, with “something you have” e.g., a security token or biometric feature. The token may be provided in software or hardware, and is usually embodied as a lengthy code, which need not, but may change according to an algorithm known to the resource provider. One example of a typical multifactor hardware token is the RSA SecurID Hardware Authenticator. The RSA SecurID authentication mechanism consists of a “token” which is assigned to a computer user and which generates an authentication code at fixed intervals (usually 60 seconds) using a built-in clock and the token's factory-encoded random key; known as the “seed”. The seed is different for each token, and is loaded into the corresponding RSA SecurID server as the tokens are purchased. A user authenticating to a network resource using a SecurID token is required to enter both a personal identification number and the number being displayed at that moment on their RSA SecurID token. Some systems using RSA SecurID disregard PIN implementation altogether, and rely on password/RSA SecurID code combinations. The server, which also has a real-time clock and a database of valid cards with the associated seed records, computes what number the token is supposed to be showing at that moment in time, checks it against what the user entered, and makes the decision to allow or deny access. There are also implementations of RSA SecurID which generate the authentication information purely in software (“Soft Tokens”).

In more extreme cases the token can be biometric, e.g. a retina or fingerprint, or facial scan of the authorized user. The purpose of all of these systems is to prove the identity of a person.

These systems are vulnerable however, to attempts to impersonate an authorized user by theft of the token. This can either be due to physical theft of a hardware device generating the multifactor token, such as an RSA SecurID tag, or through indirect means such as a man-in-the-middle attack (“MITM”). In the latter case, the user's transmitted multifactor authentication information is intercepted prior to reaching the desired computing resource. The authentication information can be intercepted for example, by malicious software executing on the user's access hardware. If attackers can intercept the user's attempt to authenticate, they can use the captured credentials to authenticate on their own behalf, thereby gaining access to the resource

Antivirus software for identifying and neutralizing malicious programs on computer systems and networks is also known. This software is typically installed on a hardware device by an authenticated user. It is executed manually or automatically on a periodic basis, and also can be updated on a periodic basis in order to identify and neutralize new malicious programs as they come into existence. This type of security measure protects personal hardware internetworked to other computers from malicious attacks.

Both antivirus and user authentication software can be provided on hardware tokens such as USB sticks or other storage devices such as flash drives and the like. In these cases the security software can be executed either directly on the storage device or downloaded for execution on the hardware.

With the rapid growth of cloud computing, both the programs used and the data generated are located in the cloud, making user authentication even more important. Users want authentication systems to safeguard their data and resource providers want authentication to prevent unauthorized access to their programming resources. These security issues are exacerbated because the cloud permits users to access data and resources from multiple devices over multiple types of access networks, including public Wi-Fi (whether password ‘protected’ or not) and other data networks for which the user does not have administrative access to or physical security control over the user's access connection to the Internet. In such cases, the user has little if any knowledge or assurance about the security of the user's access connection to the Internet and therefore the user's authentications for cloud data and resources are vulnerable to theft, not only by the access connection administrator/owner but by malicious code placed on hardware supporting the access connection as well as by interception of data representing user authentications sent over the access connection. What is needed therefore is a security system for cloud computing that will improve the security of users' authentications to cloud data and resources.

Proxy servers and Virtual Private Network connections are both known technologies for improving the security of computing resources accessed over data networks. Proxy servers are owned and/or controlled by the party at one end of the data transmission. For example, the computer resource provider might also use a proxy server to examine presented user authentications, or to safeguard the application server. Virtual Private Networks (VPN) enable secure data sharing over public networks between two private computer resources owned or controlled by the same administrator. VPNs are commonly used by corporations to provide employees with remote access to computing resources by tunneling or otherwise bypassing security applicable to other types of Internet connections to the private resources.

What is needed, however, is a server improving the security accessing Internetworked computer resources, especially over public access connections, without requiring additional servers from either the resource provider or the authenticating user.

### SUMMARY OF THE INVENTION

Accordingly, it is an object of the invention to provide a system and method that improves the security of user authentications transmitted over Internet access connections over which users do not have administrative rights and/or physical security control.

Another object is to provide a system and method improving cloud computing security in which user authentication is transmitted after the user confirms administrative rights and/or physical security control over the user's access connection to the Internet.

Still another object is to provide a system and method improving cloud computing security in which the hardware used to provide the access connection to the Internet is analyzed for malicious code before the user authentication is transmitted.

Yet another object of the invention is to provide a system and method improving cloud computing which executes on a hardware token to analyze confidence of devices used to provide the Internet access connection and thereafter transmit user authentication for access to the cloud data and/or resource.

A further object is to provide a server and method improving cloud computing security in which user authentication to cloud resources requires transmitting the authentication over data networks for which the user does not have administrative access to or physical security control over the user's access connection to the Internet.

Still a further object is to provide a server and method receiving encrypted resource requests from users which include user authentications to be forwarded by the server to the resource improving security of user authentications transmitted over data networks for which the user does not have administrative access to or physical security control over the user's access connection to the Internet.

Yet a further object is to provide a hardware token and method which encrypts user resource requests which include user authentications for transmission to a server over data networks for which the user does not have administrative access to or physical security control over the user's access connection to the Internet to improve the security of the user authentication.

These and other objectives are achieved by providing a security system for cloud computing comprising a computing resource available over a network; an authentication permitting use of the computing resource; hardware connected to the network by an access connection enabling a user to access the computing resource, the hardware having a hardware processor; a security server in communication with both the hardware and the computing resource over the network, the security server having a server processor, the security server not sharing administrative or physical security control with either of the hardware or the computing resource; software executing on the hardware processor for encrypting the authentication and for transmitting it to the security server; and software executing on the server processor for decrypting the authentication and for transmitting it to the computing resource, whereby the risk of transmitting the authentication over an insecure access connection to the network is reduced.

In some embodiments software is provided executing on the hardware for analyzing security of the access connection. In some embodiments the analyzing software includes antivirus software or port scanning software. In some embodiments the scanning software wirelessly scans the access connection.

In some embodiments the encrypting and transmitting software executes only after the analyzing software confirms security of the access connection to a predetermined level.

In some embodiments the analyzing software accepts the access connection as trusted if a user indicates administrative control over the access connection. In some embodiments the analyzing software accepts the access connection as trusted if a user indicates physical security control over the access connection.

In some embodiments, an external memory device connectable to the hardware is provided, which includes the analyzing software, authentication, and/or encrypting and transmitting software.

Other objects of the present invention are achieved by providing a security system for cloud computing comprising a computing resource available over a network; an authentication permitting use of the computing resource; hardware for use by a user to access the computing resource, the hardware having a hardware processor; an access connection connecting the hardware to the computing resource; a security server in communication with both the hardware over the access connection and the computing resource over the network, the security server having a server processor, the security server not sharing administrative or physical security control with either of the hardware or the computing resource; software executing on the hardware processor for encrypting the authentication and for transmitting it to the security server; and software executing on the server processor for decrypting the authentication and for transmitting it to the computing resource, whereby the risk of transmitting the authentication over an insecure access connection to the network is reduced.

In some embodiments the access connection to the network does not share administrative or physical security control with either of the hardware or the computing resource.

In some embodiments the authentication includes a multifactor in addition to username and password. The multifactor may be biometric, and may be provided on an external memory device connectable to the hardware.

In some embodiments the computing resource includes data. The data may have been previously stored on the network by the user, and may have been previously processed on the computing resource.

Other objects of the present invention are achieved by providing a method of secure computer communications comprising the steps of providing a computing resource available over a network, the computing resource requiring an authentication for use; providing hardware for use by a user to access the computing resource, the hardware having a hardware processor, and encryption software executing on the hardware processor; providing an access connection which connects the hardware to the computing resource over the network; providing a security server having a server processor, and decryption software executing on the server processor, the security server not sharing administrative or physical security control with the hardware or the computing resource; issuing a request for the authentication from the computing resource to the hardware; connecting the security server with the hardware over the access connection; encrypting the authentication using the encryption software and transmitting the authentication as encrypted to the security server; connecting the security server with the computing resource over the network; decrypting the authentication using the decryption software and transmitting the authentication to the computing resource.

In some embodiments the network is the Internet. In some embodiments hardware is a public computer, a mobile phone, or a tablet.

Other objects of the present invention are achieved by providing a method of secure computer communications comprising the steps of providing a computing resource available over a network, the computing resource requiring an authentication for use; providing hardware for use by a user to access the computing resource, the hardware having a hardware processor, providing a hardware token connected to the hardware and encryption software executing on the hardware token; providing an access connection which connects the hardware to the computing resource over the network; providing a security server having a server processor, and decryption software executing on the server processor, the security server not sharing administrative or physical security control with the hardware or the computing resource; issuing a request for the authentication from the computing resource to the hardware; connecting the security server with the hardware over the access connection; encrypting the authentication using the encryption software and transmitting the authentication as encrypted to the security server; connecting the security server with the computing resource over the network; and, decrypting the authentication using the decryption software and transmitting the authentication to the computing resource.

In some embodiments analyzing software is provided executing on the hardware processor which permits encrypting and transmitting the authentication only after the analyzing software confirms security of the access connection to a predetermined level.

The invention and its particular features and advantages will become more apparent from the following detailed description considered with reference to the accompanying drawings.

### BRIEF DESCRIPTION OF THE DRAWINGS

FIG. 1 is a block diagram of an example system for secure user authentications using a third party authentication server according to aspects of the invention.

FIG. 2 is a block diagram of a prior art system for user authentications.

FIG. 3 is a block diagram of a prior art system for secure user authentications using a proxy server.

FIG. 4 is a block diagram of a prior art system for secure user authentications using a VPN server.

FIG. 5 is a block diagram of a method for secure user authentications using a third party authentication server according to aspects of the invention.

FIG. 6 is a block diagram of an example system for secure user authentications using a third party authentication server and an external hardware token according to aspects of the invention.

### DETAILED DESCRIPTION OF THE INVENTION

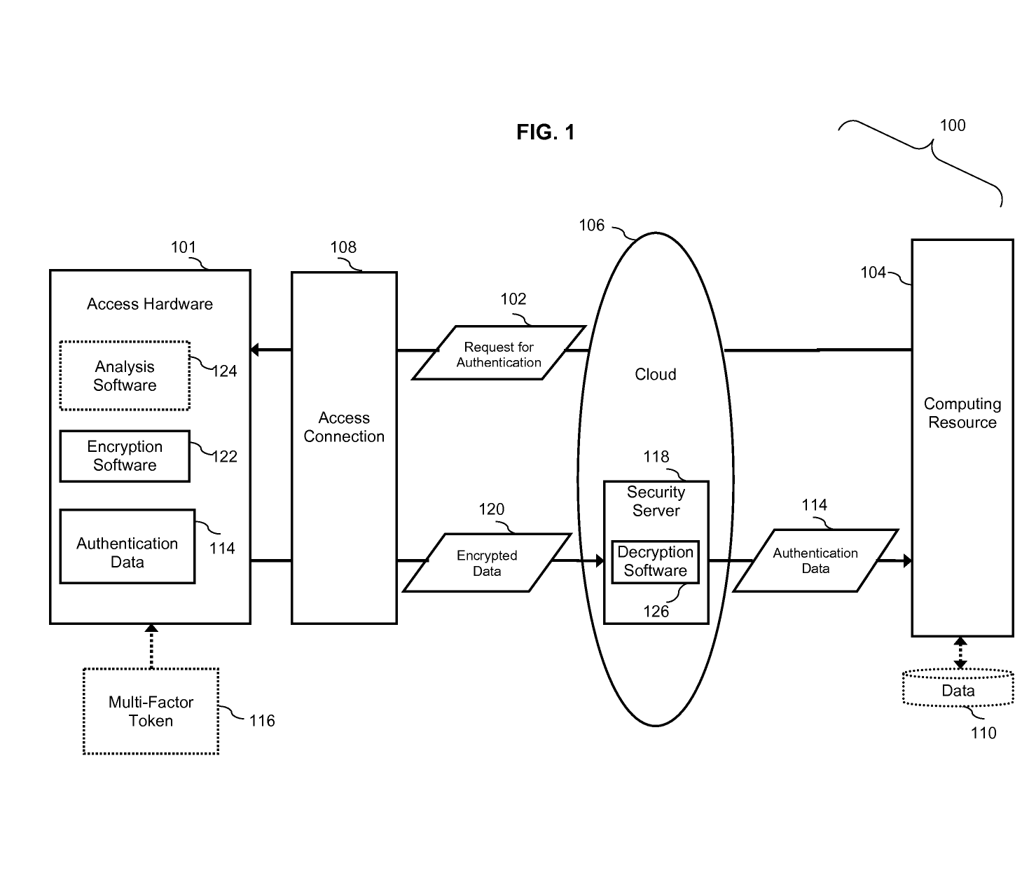

FIG. 1. Illustrates a system 100 for secure user authentications using a third party authentication server, where authentications are transmitted using an access connection over which the user does not have administrative rights and/or physical security control.

In system 100, access hardware 101 communicates with cloud computing resource 104 via cloud 106 and access connection 108.

Access hardware 101 may be a public computer, mobile telephone, tablet computer, laptop computer, or other suitable hardware for accessing a remote computing resource. Access hardware 101 includes a processor (not shown) and includes encryption software 122, which executes on the processor. Optionally, access hardware 101 includes analysis software 124. Analysis software 124 may include antivirus software, a port scanner, or other security software known in the art for securing an access connection.

Cloud 106 may be a computer network, such as the Internet or a subset of the Internet, a wide-area-network, local-area-network, private network of computing infrastructure, or other arrangement of interconnected computing equipment at the application, platform, or infrastructure level, or other cloud computing layers of abstraction.

Third party security server 118 is connected to cloud 106, and includes a processor (not shown). Third party security server 118 communicates with access hardware 101 via access connection 108, and communicates with computing resource 104. Third party security server 118 includes decryption software 126, which executes on the processor.

Access connection 108 may be any suitable connection to cloud 106 which enables communications between access hardware 101 and cloud 106, and may include supporting hardware and software components. Examples include a wireless LAN connection, wired LAN connection, 3G wireless connection, public Wi-Fi, or other suitable access connection to the Internet or to other computing networks which form a part of cloud 106.

The user does not have administrative rights or physical security control over access connection 108 and/or cloud 106.

Computing resource 104 may be connected to storage or a database 110, and may be a computer server, infrastructure-as-a-service system, platform virtualization environment, platform-as-a-service system, software-as-a-service application, or other typical cloud computing resource or group of resources. Computing resource 104 requires authentication data 114 for access from access hardware 101.

Authentication data 114 may include one or more of a personal identifier, password, or the like. Authentication data 114 may be entered by the user on access hardware 101. Optionally, authentication data 114 may incorporate multifactor information 116, such as a mathematically generated code or biometric data, for example. Optionally, multifactor information 116 is provided on a hardware token (not shown), such as an external memory or biometric scanner connectible to access hardware 101, or a mathematical code generator, for example.

Computing resource 104 can send a request for authentication 102 to access hardware 101 via cloud 106 and access connection 108. Access hardware 101 can receive request for authentication 102.

Upon receiving a request for authentication 102, access hardware 101 thereafter transmits authentication data 114 to computing resource 104 via third party security server 118.

Third party security server 118 is in communication with, or is a part of, cloud 106. Third party security server 118 includes a processor (not shown) and decryption software 126 which executes on the processor.

Authentication data 114 is encrypted prior to transmission by encryption software 122. The encrypted authentication data 120 is transmitted from access hardware 101 to third party security server 118.

Third party security server 118 decrypts encrypted authentication data 120 using decryption software 126, which executes on a processor of third party security server 118, and transmits the decrypted authentication data 114 to computing resource 104.

Optionally, analysis software 124 executes on access hardware 101 prior to encryption of authentication data 114 and/or transmission of encrypted data 120. Analysis software 124 optionally analyzes the security of access connection 108. If access connection 108 includes a wireless connection, analysis software 124 may scan access connection 108 wirelessly.

Analysis software 124 optionally prevents encryption of authentication data 114 and/or transmission of encrypted authentication data 120 unless access connection 108 is determined to be secure. Optionally, analysis software 124 may also determine if access hardware 101 is secure prior to encryption and/or transmission.

Optionally, analysis software 124 accepts access connection 108 as trusted if the user indicates administrative or physical control over the access connection 108. Control over access connection 108 may be indicated by a confirmation, where the user affirms control, or the user may be required to provide a username and password, or multifactor, for example.

Optionally, the analysis software 124 analyzes access connection 108 for malicious code or other vulnerabilities prior to transmitting encrypted authentication data 120 from access hardware 101. Analyzing the access connection 108 for malicious code can entail any known ways of verifying access connection security including executing virus software to analyze the hardware and software supporting access connection 108 for malicious code, or executing a port scanner to detect vulnerabilities or compromised security in access connection 108.

Optionally, analysis software 124 determines confidence in the access connection 108 prior to transmitting encrypted authentication data 120. Confidence may optionally be assessed by scanning access connection 108 for vulnerabilities as described above, and determining a level of trust. For example, the level of trust in access connection 108 can be assigned a ranking based on its component software, number and type of open ports, or other potential security concerns. Access connection 108 may be required to achieve a desired level of trust prior to transmitting encrypted authentication data 120.

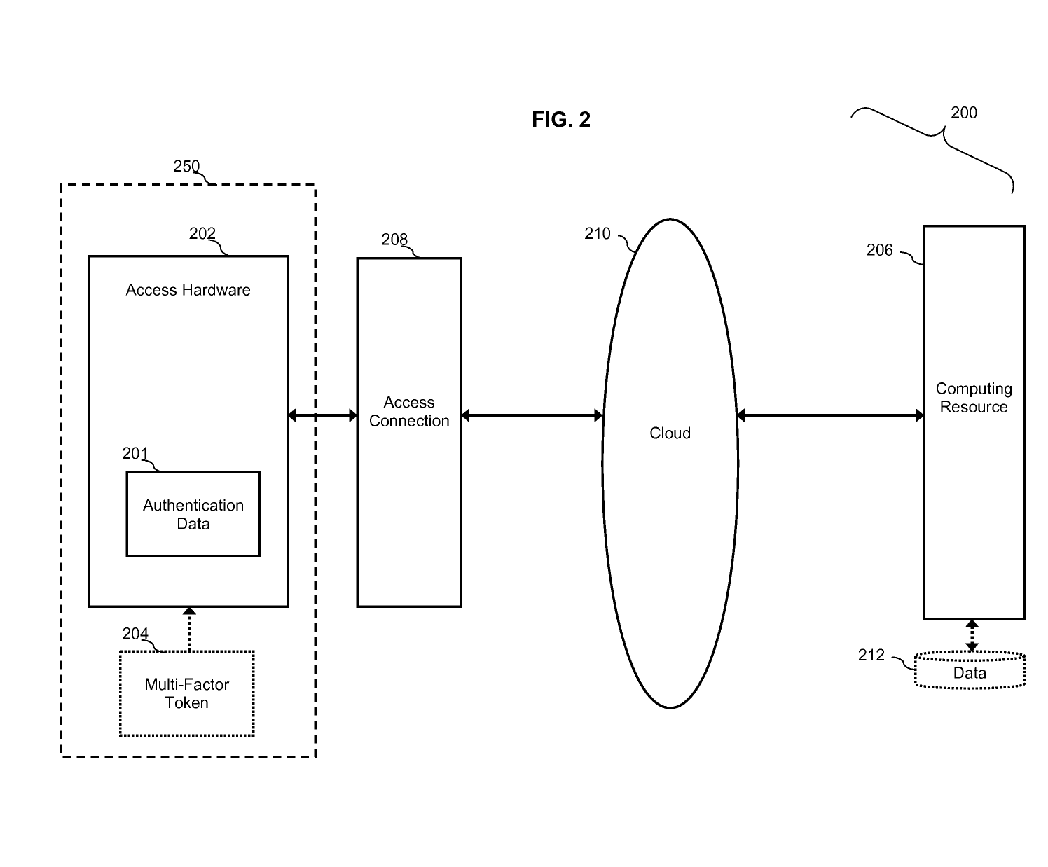

FIG. 2 illustrates a prior art system 200 for user authentication to a computing resource over an insecure access connection.

Access hardware 202 communicates with a cloud computing resource 206 via cloud 210 over an access connection 208. Computing resource 206 requires an authentication 201 for access by access hardware 202.

Access hardware 202 may be a public computer, mobile telephone, tablet computer, laptop computer, or other suitable hardware for accessing a remote computing resource.

Cloud 210 may be a computer network, such as the Internet or a subset of the Internet, a wide-area-network, local-area-network, private network of computing infrastructure, or other arrangement of interconnected computing equipment at the application, platform, or infrastructure level, or other cloud computing layers of abstraction.

Access connection 208 may be any suitable connection to cloud 210 which enables communications between access hardware 202 and cloud 210, and may include supporting hardware and software components. Examples include a wireless LAN connection, wired LAN connection, 3G wireless connection, public Wi-Fi, or other suitable access connection to the Internet or to other computing networks which form a part of cloud 210.

The user does not have administrative rights or physical security control over access connection 208 and/or cloud 210. The user may have administrative rights or physical security control 250 over access hardware 202.

Computing resource 206 may be connected to storage or a database 212, and may be a computer server, infrastructure-as-a-service system, platform virtualization environment, platform-as-a-service system, software-as-a-service application, or other typical cloud computing resource or group of resources.

Computing resource 206 requires user authentication 201 for access. Access hardware 202 is in communication with computing resource 206 via access connection 208 and cloud 210. User authentication 201 is transmitted from access hardware 202 to computing resource 206 via access connection 208 and cloud 210. User authentication 201 optionally incorporates a multifactor token 204.

Access hardware 202 and optional multifactor token 204 are each under the administrative and/or physical security control of the user. Access connection 208, cloud 210, and computing resource 206 are all outside of the user's administrative or physical security control.

User authentication 201 is transmitted unencrypted over access connection 208 and cloud 210. Accordingly, it remains unclear in prior art system 200 if the access connection 208 is insecure or compromised, or if the transmitted user authentication 201 has been intercepted.

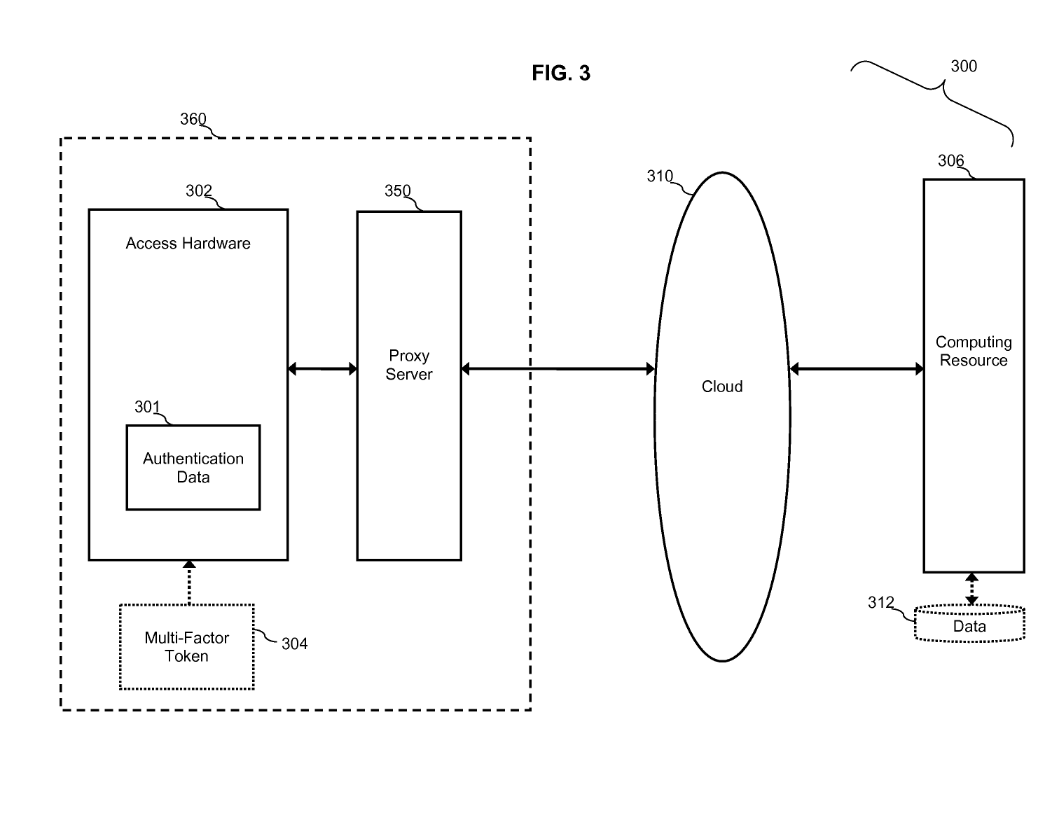

FIG. 3. illustrates a prior art system for secure user authentications using a proxy server 350.

Access hardware 302 communicates with a cloud computing resource 306 via cloud 310 and proxy server 350. Computing resource 306 requires an authentication 301 for access by access hardware 302.

Access hardware 302 may be a public computer, mobile telephone, tablet computer, laptop computer, or other suitable hardware for accessing a remote computing resource.

Cloud 310 may be a computer network, such as the Internet or a subset of the Internet, a wide-area-network, local-area-network, private network of computing infrastructure, or other arrangement of interconnected computing equipment at the application, platform, or infrastructure level, or other cloud computing layers of abstraction.

Proxy server 350 acts as an intermediary between access hardware 302 and cloud 310, and may be a computer system and/or software application.

The user has administrative rights and/or physical security control 360 over access hardware 302, as well as proxy server 350. The user does not have administrative rights or physical security control over cloud 310.

Computing resource 306 may be connected to storage or a database 312, and may be a computer server, infrastructure-as-a-service system, platform virtualization environment, platform-as-a-service system, software-as-a-service application, or other typical cloud computing resource or group of resources.

Computing resource 306 requires user authentication 301 for access. Access hardware 302 is in communication with computing resource 306 via proxy server 350 and cloud 310. User authentication 301 is transmitted from access hardware 302 to computing resource 306 via proxy server 350 and cloud 310, optionally incorporating a multifactor token 304.

User authentication 301 is transmitted unencrypted over proxy server 350 and cloud 310. Because access hardware 302, proxy server 350, and communications between them are within the user's administrative and physical security control, transmission of user authentication 301 via this portion of system 300 may be trusted. However, this has the disadvantage of requiring the expense of maintaining infrastructure and the administrative and physical security of a proxy server.

In addition, depending upon the connection between the proxy server 350 and cloud 310, it may be unclear in prior art system 300 if this portion of the communication between access hardware 302 and computing resource 306 is insecure or compromised, or if the transmitted user authentication 301 has been intercepted.

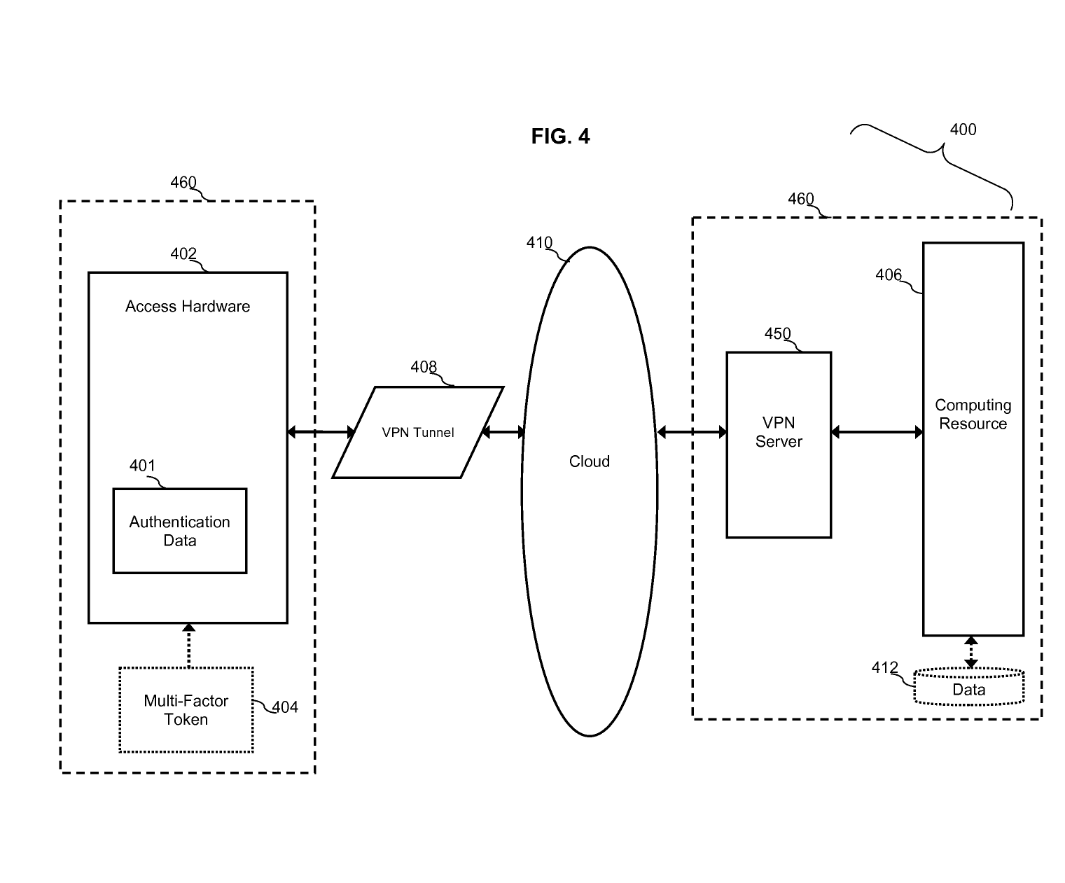

FIG. 4 illustrates a prior art system for secure user authentications using a VPN server 450.

Access hardware 402 communicates with a cloud computing resource 406 via cloud 410 and VPN server 450. Computing resource 406 requires an authentication 401 for access by access hardware 402.

Access hardware 402 may be a public computer, mobile telephone, tablet computer, laptop computer, or other suitable hardware for accessing a remote computing resource.

Cloud 410 may be a computer network, such as the Internet or a subset of the Internet, a wide-area-network, local-area-network, private network of computing infrastructure, or other arrangement of interconnected computing equipment at the application, platform, or infrastructure level, or other cloud computing layers of abstraction.

VPN server 450 includes encryption software, and encrypts communications between access hardware 302 and computing resource 406. VPN server 450 may include a computer system and/or software application.

The user has administrative rights and physical security control 460 over access hardware 402, as well as VPN server 450, and computing resource 406. The user does not have administrative rights or physical security control over cloud 410.

Computing resource 406 may be connected to storage or a database 412, and may be a computer server, infrastructure-as-a-service system, platform virtualization environment, platform-as-a-service system, software-as-a-service application, or other typical cloud computing resource or group of resources.

Computing resource 406 requires user authentication 401 for access by access hardware 402. User authentication data 401 optionally incorporates a multifactor token 404.

Access hardware 402 is in communication with computing resource 406 via VPN server 450 and cloud 410.

User authentication 401 is transmitted to computing resource 406 using an encrypted VPN tunnel 408 established between access hardware 402 and VPN server 450 over cloud 310. VPN Server 450 forwards user authentication 401 to computing resource 406. Because access hardware 402, VPN server 450, and communications between them are encrypted, transmission of user authentication 301 via this portion of system 300 may be trusted. However, this has the disadvantage of requiring the expense of maintaining infrastructure and the administrative and physical security of a VPN server, and also requires that unencrypted communications between the VPN server 450 and computing resource 406 be under the user's administrative and physical security.

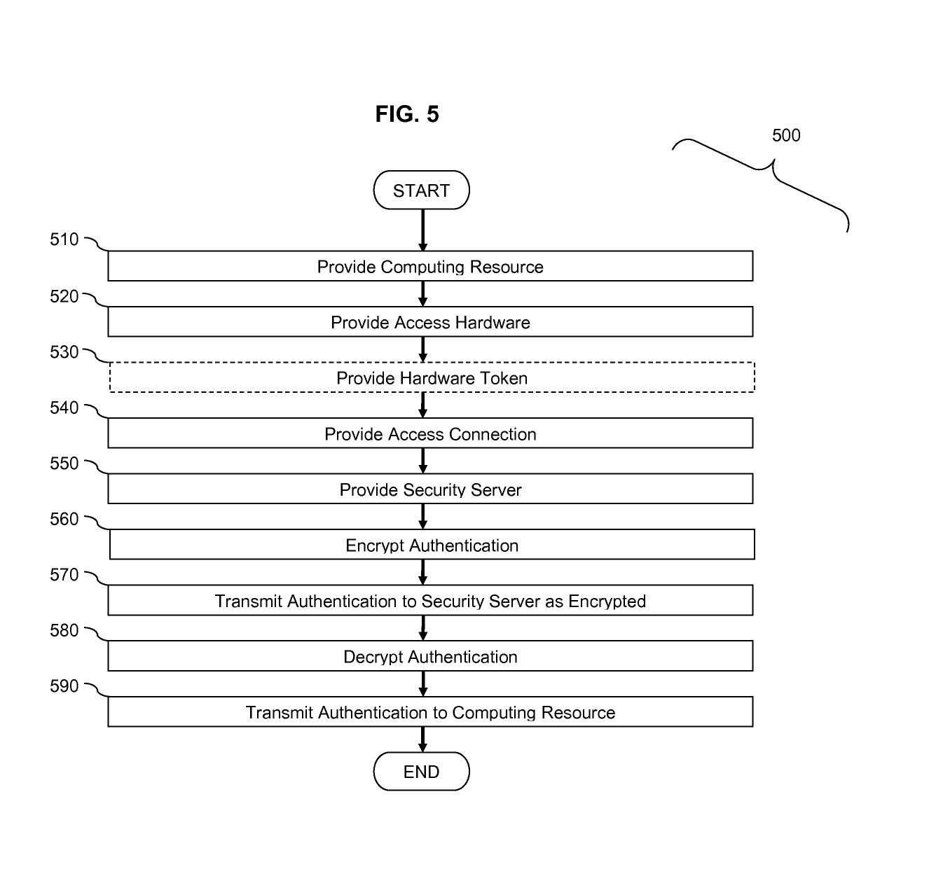

FIG. 5 Illustrates an example method 500 according to aspects of the invention for secure user authentications using a third party authentication server, where the authentications are transmitted using Internet access connections over which users do not have administrative rights and/or physical security control.

In step 510, a cloud computing resource is provided which requires user authentication data for use. Optionally, user authentication data may incorporate a multifactor token.

The cloud computing resource may be a computer server, infrastructure-as-a-service system, platform virtualization environment, platform-as-a-service system, software-as-a-service application, or other typical cloud computing resource or group of resources, and may be connected to a database and a cloud or a network such as the Internet.

In step 520, access hardware is provided, having a hardware processor and which can communicate with the cloud computing resource over a network.

The access hardware may be a user computer and may be a public computer, mobile telephone, tablet computer, laptop computer, modem, router, connection hardware, or other suitable hardware for accessing a remote computing resource, and includes a hardware processor. The access hardware also includes encryption software which executes on the hardware processor.

In an optional step 530, a hardware token is provided connected to the access hardware. The hardware token may be a, USB flash drive, or other suitable external memory device, which is connectible to the access hardware, and includes a multifactor token. In alternative methods according to the invention, the encryption software may be provided on, and may execute on the hardware token.

In step 540, an access connection is provided which connects the access hardware to the computing resource via the cloud. The user does not have administrative rights or physical security control over the access connection or the cloud.

The access connection may be any suitable connection to cloud which enables communications between the access hardware and the cloud, and may include supporting hardware and software components. Examples include a wireless LAN connection, wired LAN connection, 3G wireless connection, public Wi-Fi, or other suitable access connection to the Internet or to other computing networks which form a part of the cloud.

In step 550, a third party security server is provided. The third party security server includes a server processor, and decryption software executing on the server processor. The third party security server is in communication with, or is a part of the cloud.

In step 560, the user authentication data is encrypted by the encryption software.

In step 570 the encrypted user authentication data is transmitted to the security server via the access connection and the cloud.

In step 580, the security server receives the encrypted user authentication data and decrypts it.

In step 590, the security server transmits the decrypted user authentication data to the computing resource.

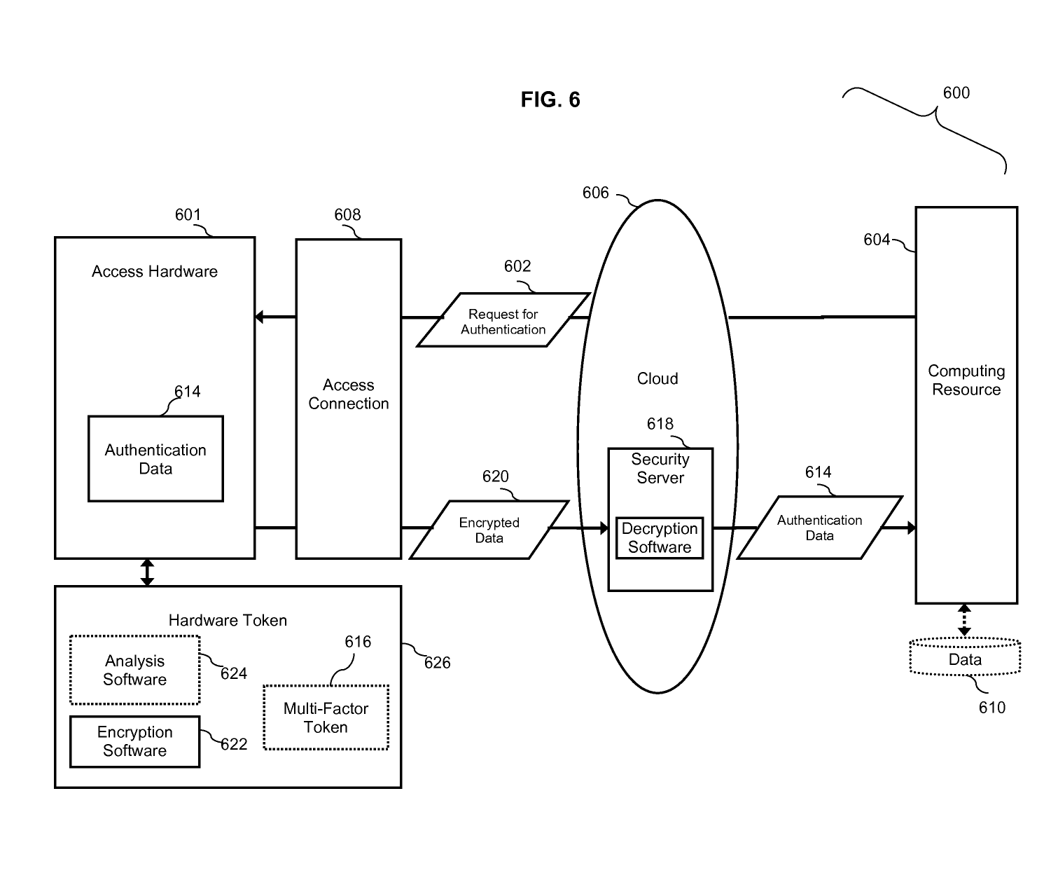

FIG. 6. Illustrates a system 600 for secure user authentications using a third party authentication server, where authentications are transmitted using an access connection over which the user does not have administrative rights and/or physical security control.

In system 600, access hardware 601 communicates with cloud computing resource 604 via cloud 606 through access connection 608.

Access hardware 601 may be a public computer, mobile telephone, tablet computer, laptop computer, or other suitable hardware for accessing a remote computing resource. Access hardware 601 includes a processor (not shown).

Hardware token 626 is connected to access hardware 601. Hardware token 626 may be removable, and includes a physical memory (not shown). Hardware token 626 optionally includes a processor (not shown). Hardware token 626 includes encryption software 626, which executes from the hardware token. Optionally, hardware token 626 includes analysis software 624. Analysis software 624 may include antivirus software, a port scanner, or other security software known in the art for securing an access connection.

Cloud 606 may be a computer network, such as the Internet or a subset of the Internet, a wide-area-network, local-area-network, private network of computing infrastructure, or other arrangement of interconnected computing equipment at the application, platform, or infrastructure level, or other cloud computing layers of abstraction.

Third party security server 618 is connected to, or forms a part of cloud 606, and includes a processor (not shown). Third party security server 118 communicates with access hardware 601 via access connection 608, and communicates with computing resource 604. Third party security server 618 includes decryption software 626, which executes on the processor.

Access connection 608 may be any suitable connection to cloud 606 which enables communications between access hardware 601 and cloud 606, and may include supporting hardware and software components. Examples include a wireless LAN connection, wired LAN connection, 3G wireless connection, public Wi-Fi, or other suitable access connection to cloud 606.

The user may not have administrative rights or physical security control over access hardware 601, access connection 608 and/or cloud 606.

Computing resource 604 may be connected to storage or a database 610, and may be a computer server, infrastructure-as-a-service system, platform virtualization environment, platform-as-a-service system, software-as-a-service application, or other typical cloud computing resource or group of resources. Computing resource 604 requires authentication data 614 for access from access hardware 601.

Authentication data 614 may include one or more of a personal identifier, password, or the like. Authentication data 614 may be entered by the user on access hardware 601. Optionally, authentication data 614 may incorporate multifactor information 616, such as a mathematically generated code or biometric data, for example. Optionally, multifactor information 616 is provided on the hardware token 626 which is connected to access hardware 601.

Computing resource 604 can send a request for authentication 602 to access hardware 601 via cloud 606 and access connection 608. Access hardware 601 can receive request for authentication 602.

Upon receiving a request for authentication 602, access hardware 601 thereafter transmits authentication data 614 to computing resource 604 via third party security server 618.

Third party security server 618 is in communication with, or is a part of, cloud 606. Third party security server 618 includes a processor (not shown) and decryption software 626 which executes on the processor.

Authentication data 614 is encrypted prior to transmission by encryption software 622. The encrypted authentication data 620 is transmitted from access hardware 601 to third party security server 618.

Third party security server 618 decrypts encrypted authentication data 620 using decryption software 626, which executes on a processor of third party security server 618, and transmits the decrypted authentication data 614 to computing resource 604.

Optionally, analysis software 624 executes on hardware token 626 prior to encryption of authentication data 614 and/or transmission of encrypted data 620. Analysis software 624 optionally analyzes the security of access connection 608. If access connection 608 includes a wireless connection, analysis software 624 may scan access connection 608 wirelessly.

Analysis software 624 optionally prevents encryption of authentication data 614 and/or transmission of encrypted authentication data 620 unless access connection 608 is determined to be secure. Optionally, analysis software 624 may also determine if access hardware 601 is secure prior to encryption and/or transmission.

Optionally, analysis software 624 accepts the access connection as trusted if the user indicates administrative control over the access connection 608. Control over access connection 608 may be indicated by a confirmation, where the user affirms control, or the user may be required to provide a username and password, or multifactor, for example.

Optionally, the analysis software 624 analyzes access connection 608 for malicious code or other vulnerabilities prior to transmitting encrypted authentication data 620 from access hardware 601. Analyzing the access connection 608 for malicious code can entail any known ways of verifying access connection security including executing virus software to analyze the hardware and software supporting the access connection for malicious code, or executing a port scanner to detect vulnerabilities or compromised security in the access connection.

Optionally, analysis software 624 determines confidence in the internet access connection 608 prior to transmitting encrypted authentication data 620. Confidence may optionally be assessed by scanning the access connection for vulnerabilities as described above, and determining a level of trust. For example, the level of trust in access connection 608 can be assigned a ranking based on its component software, number and type of open ports, or other potential security concerns. Access connection 608 may be required to achieve a desired level of trust prior to transmitting encrypted authentication data 620.

Although the invention has been described with reference to a particular arrangement of parts, features and the like, these are not intended to exhaust all possible arrangements or features, and indeed many modifications and variations will be ascertainable to those of skill in the art.

What is claimed is:

1. A security system for cloud computing comprising:
a computing resource available over a network;
an authentication permitting use of said computing resource;
hardware connected to the network by an access connection enabling a user to access said computing resource, said hardware having a hardware processor;
a security server in communication with both said hardware and said computing resource over the network, said security server having a server processor, said security server not sharing administrative or physical security control with either of said hardware or said computing resource;
software executing on the hardware processor for encrypting said authentication and for transmitting it to said security server; and
software executing on the server processor for decrypting said authentication and for transmitting it to said computing resource,
whereby the risk of transmitting said authentication over an insecure access connection to the network is reduced.

2. The security system of claim 1 including software executing on said hardware for analyzing security of the access connection.

3. The security system of claim 2 in which the analyzing software is antivirus software.

4. The security system of claim 2 in which the analyzing software is port scanning software.

5. The security system of claim 4 in which the scanning software wirelessly scans the access connection.

6. The security system of claim 2 in which said encrypting and transmitting software executes only after the analyzing software confirms security of the access connection to a predetermined level.

7. The security system of claim 6 in which the analyzing software accepts the access connection as trusted if a user indicates administrative control over the access connection.

8. The security system of claim 6 in which said analyzing software accepts the access connection as trusted if a user indicates physical security control over the access connection.

9. The security system of claim 2 in which said analyzing software is provided on an external memory device connectable to said hardware.

10. The security system of claim 9 in which the external memory device includes said authentication.

11. The security system of claim 9 in which the external memory device includes said encrypting and transmitting software.

12. A security system for cloud computing comprising:
a computing resource available over a network;
an authentication permitting use of said computing resource;
hardware for use by a user to access said computing resource, said hardware having a hardware processor;
an access connection connecting said hardware to said computing resource;
a security server in communication with both said hardware over said access connection and said computing resource over the network, said security server having a server processor, said security server not sharing administrative or physical security control with either of said hardware or said computing resource;
software executing on the hardware processor for encrypting said authentication and for transmitting it to said security server; and
software executing on the server processor for decrypting said authentication and for transmitting it to said computing resource,
whereby the risk of transmitting said authentication over an insecure access connection to the network is reduced.

13. The security system of claim 12 in which the access connection to the network does not share administrative or physical security control with either of said hardware or said computing resource.

14. The security system of claim 12 in which said authentication includes a multifactor in addition to username and password.

15. The security system of claim 14 in which said multifactor is biometric.

16. The security system of claim 15 in which said multifactor is provided on an external memory device connectable to said hardware.

17. The security system of claim 12 in which said computing resource includes data.

18. The security system of claim 17 in which the data was previously stored on the network by the user.

19. The security system of claim 18 in which the data was previously processed on said computing resource.

20. A method of secure computer communications comprising the steps of:
providing a computing resource available over a network, the computing resource requiring an authentication for use;
providing hardware for use by a user to access the computing resource, the hardware having a hardware processor, and encryption software executing on the hardware processor;
providing an access connection which connects the hardware to the computing resource over the network;
providing a security server having a server processor, and decryption software executing on the server processor, the security server not sharing administrative or physical security control with the hardware or the computing resource;
issuing a request for the authentication from the computing resource to the hardware;
connecting the security server with the hardware over the access connection;
encrypting the authentication using the encryption software and transmitting the authentication as encrypted to the security server;
connecting the security server with the computing resource over the network;
decrypting the authentication using the decryption software and transmitting the authentication to the computing resource.

21. The method of claim 20 in which the network is the Internet.

22. The method of claim 20 in which said hardware is a public computer.

23. The method of claim 20 in which said hardware is a mobile phone.

24. method of claim 20 in which said hardware is a tablet.

25. A method of secure computer communications comprising the steps of:
providing a computing resource available over a network, the computing resource requiring an authentication for use;
providing hardware for use by a user to access the computing resource, the hardware having a hardware processor,
providing a hardware token connected to the hardware and encryption software executing on the hardware token;
providing an access connection which connects the hardware to the computing resource over the network;
providing a security server having a server processor, and decryption software executing on the server processor, the security server not sharing administrative or physical security control with the hardware or the computing resource;
issuing a request for the authentication from the computing resource to the hardware;
connecting the security server with the hardware over the access connection;
encrypting the authentication using the encryption software and transmitting the authentication as encrypted to the security server;
connecting the security server with the computing resource over the network; and,
decrypting the authentication using the decryption software and transmitting the authentication to the computing resource.

26. The method of claim 25, further comprising
providing analyzing software executing on the hardware processor which permits encrypting and transmitting said authentication only after the analyzing software confirms security of the access connection to a predetermined level.
